(19) United States
(12) Patent Application Publication
(10) Pub. No.: US 2012/0192226 A1
(43) Pub. Date: Jul. 26, 2012

(54) Methods and Systems for Customized Video Modification

(75) Inventors: Claus Zimmerman, Ellerhoop (DE); Malte John, Hamburg (DE); Philipp Beyer, Ahrensburg (DE); Lars Ogitani, Hamburg (DE); Gerhard Häring, Hamburg (DE)

(73) Assignee: Impossible Software GmbH

(21) Appl. No.: 13/353,733

(22) Filed: Jan. 19, 2012

Related U.S. Application Data
(60) Provisional application No. 61/435,006, filed on Jan. 21, 2011.

(51) Int. Cl. H04N 21/458

(52) U.S. Cl. 725/34

(57) ABSTRACT

A computer-implemented method for incorporating advertisement information into a video is disclosed. The method may include receiving a request for a modified video and receiving at least one parameter for determining advertisement information to be included in the modified video. Based on the received parameter, the method may select the advertisement information to be included in the modified video. The method may also include determining an advertisement area in a video for the advertisement information to be located, and generating the modified video by integrating the advertisement information into the advertisement area in the video. Further, the method may include sending the modified video to one or more devices.

This application claims priority to U.S. Provisional Application No. 61/435,006, filed on Jan. 21, 2011, the disclosure of which is incorporated herein by reference in its entirety.

### TECHNICAL FIELD

Disclosed embodiments relate generally to customized video modification. More specifically, disclosed embodiments relate to apparatuses and processes for incorporating customized advertisement information into a video.

### BACKGROUND

Conventional systems that monetize video content have been limited to placing advertisement(s) before the content (e.g., pre-roll ads) or sometimes after or in between content (e.g., post-roll or mid-roll ads). It has proven difficult to monetize the actual content of videos because the advertiser or publisher of the content cannot say when and where an ad is to be shown best. While a publisher can choose to display ads, for example, at the very bottom of a video, there is no way to make sure that the ad is not obscuring important parts of the video content.

Moreover, with the increased speed and ubiquity of the Internet, more users have begun to stream video content to their devices. Thus, some content providers may desire to incorporate customized advertisements into the streaming video content being provided to the user. However, conventional techniques may be unable to incorporate customized advertisements quickly enough to allow them to be integrated into video content that is streamed to the user.

### SUMMARY

Systems and methods consistent with disclosed embodiments include apparatuses and processes for incorporating advertisement information into a video. The methods may include receiving a request for a modified video and receiving at least one parameter for determining advertisement information to be included in the modified video. Based on the received parameter, the method may select the advertisement information to be included in the modified video. The method may also include determining an advertisement area in a video for the advertisement information to be located, and generating the modified video by integrating the advertisement information into the advertisement area in the video. Further, the method may include sending the modified video to one or more devices.

According to other embodiments the methods may include storing a video to be modified in a database in memory. The video may include a plurality of static frames to which advertising information may not be added, and a plurality of dynamic frames to which advertising information may be added. The method may also include receiving a request to display the video. The request may include at least one parameter for determining advertisement information to be included in the video. The methods may also include determining the advertisement information to be included in the video based on the at least one parameter in the received request to display the video, and modifying the video by integrating the advertisement information into at least one of the dynamic frames of the video. Disclosed methods may also include sending the modified video to one or more devices.

Systems and apparatuses consistent with disclosed embodiments may include memory storing computer programs as well as processors configured to perform one or more disclosed methods, e.g., upon execution of one or more of the computer programs.

Additional objects and advantages of disclosed embodiments will be set forth in part in the description that follows, and in part will be obvious from the description, or may be learned by practice of the disclosed embodiments. The objects and advantages of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate several embodiments and together with the description, serve to explain the principles of the disclosed embodiments. In the drawings:

FIG. 1 is a diagram illustrating an exemplary video modification system that may be used to implement certain disclosed embodiments;

FIG. 2 is a flow diagram illustrating an exemplary process for generating a modified video that may be performed by one or more components of the video modification system shown in FIG. 1, consistent with certain disclosed embodiments;

FIGS. 3A-3C are screen shots illustrating an exemplary interface for modifying videos using one or more components of the video modification system shown in FIG. 1, consistent with certain disclosed embodiments;

FIG. 4 is an exemplary block diagram illustrating modification of video data that may be performed by one or more components of the video modification system shown in FIG. 1, consistent with certain disclosed embodiments;

FIG. 5 is a flow diagram of an exemplary process for modifying video data that may be performed by one or more components of the video modification system shown in FIG. 1, consistent with certain disclosed embodiments;

FIGS. 6A-6B are exemplary block diagrams illustrating modification of video data that may be performed by one or more components of the video modification system shown in FIG. 1, consistent with certain disclosed embodiments; and

FIG. 7 is a flow diagram of an exemplary process for modifying video data that may be performed by one or more components of the video modification system shown in FIG. 1, consistent with certain disclosed embodiments.

### DETAILED DESCRIPTION OF THE EMBODIMENTS

Reference will now be made in detail to exemplary disclosed embodiments, examples of which are illustrated in the accompanying drawings. Wherever possible, the same reference numbers will be used throughout the drawings to refer to the same or like parts. While several exemplary embodiments and features are described herein, modifications, adaptations, and other implementations are possible, without departing from the spirit and scope of the disclosed embodiments. Accordingly, the following detailed description does not limit the disclosed embodiments. Instead, the proper scope of the disclosed embodiments is defined by the appended claims.

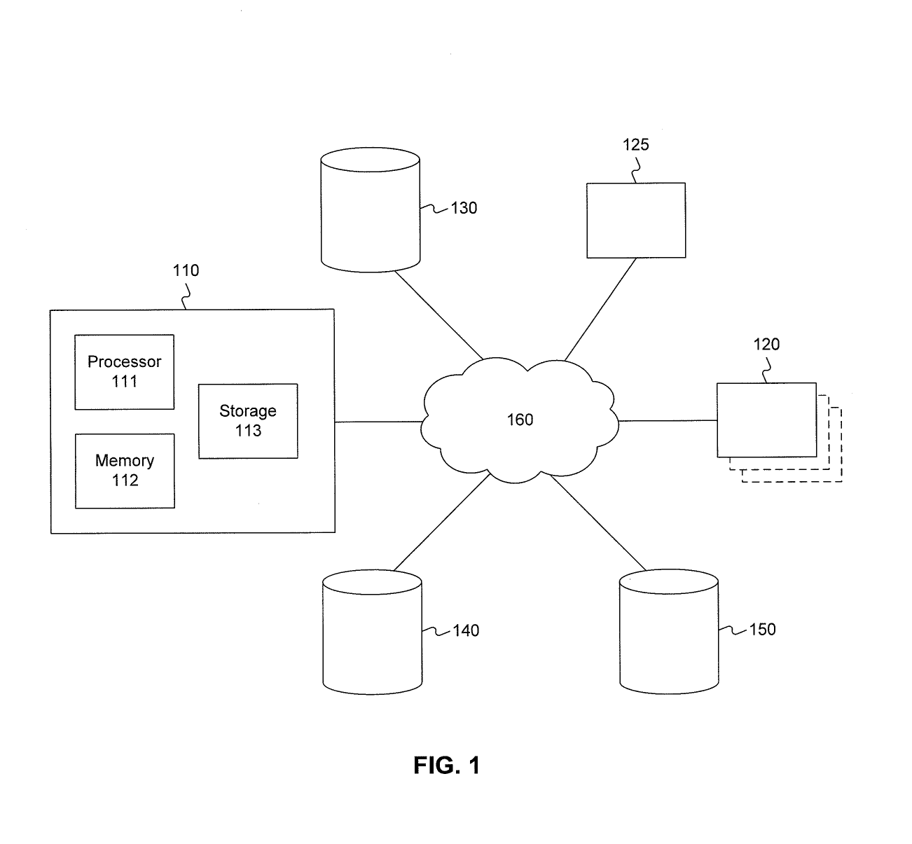

FIG. 1 is a diagram illustrating an exemplary video modification system 100 that may be used to implement certain disclosed embodiments. Video modification system 100 may include a video modification server 110, client devices 120, a content server 125, a video database 130, a dynamic resource database 140, and a user profile database 150 connected via a network 160. However, the components, the number of components, and their arrangement may be varied.

Client devices 120 may include any type of device capable of communicating with video modification server 110 and/or content server 125 via a network such as network 160. For example, client devices 120 may include personal computers, such as laptops or desktops, and/or any type of mobile device, such as a cell phone, personal digital assistant (PDA), smart phone, tablet, etc. Each client device 120 may include a processor, memory, and web browser to communicate with video modification server 110 and/or content server 125 via network 160. Client devices 120 may also include input/output (I/O) devices to enable communication with a user and with the components of video modification system 100.

Content server 125 may include one or more servers that serve content to client devices 120 over network 160. This content may include, e.g., sound, text, images, videos, etc., displayed via web pages or any other interface. For example, content server 125 may include servers for news, sports, multimedia, or any other type of web site that may be viewed on client devices 120.

Video database 130 may include one or more databases of video data including video content that may be viewed by a user. For example, video database 130 may include video content that has been previously captured by a device such as a video camera. The video content may be uploaded to video database 130 by a user at client device 120, or elsewhere. Video database 130 may be stored at one or more servers, such as video modification server 110 and/or content server 125, for example.

Dynamic resource database 140 may include one or more databases of dynamic resources that may be incorporated into video content stored on video database 130. In exemplary embodiments, the dynamic resources stored in dynamic resource database 140 may include advertisement data, such as company logos, images, slogans, celebrity representatives, etc., or information related to products being sold, such as price discounts, specification information, store locations, etc. Dynamic resource data (e.g., advertisement data) may be included in the form of audio data, textual data, graphical data, video data, etc. Dynamic resource database 140 may be stored at one or more servers, such as video modification server 110 and/or other servers connected to network 160, for example.

User profile database 150 may include information regarding one or more client devices 120 and/or one or more users of client devices 120. For example, user profile database 150 may include information regarding, e.g., the location of a client device, its browsing history, etc. Similarly, user profile database 150 may include demographic information regarding, e.g., the geographic location (e.g., residence address, work address, location determined based on GPS of the client device, etc.), social demographics, gender, ethnicity, age, etc., of a user of client device 120. This information may be obtained through browsing history, cookie information, online surveys, IP address information, etc.

Network 160 may include any one of or combination of wired or wireless networks. For example, network 160 may include wired networks such as twisted pair wire, coaxial cable, optical fiber, and/or a digital network. Likewise, network 160 may include any wireless networks such as RFID, microwave or cellular networks or wireless networks employing, e.g., IEEE 802.11 or Bluetooth protocols. Additionally, network 160 may be integrated into any local area network, wide area network, campus area network, or the Internet.

Video modification server 110 may include one or more servers that communicate with one or more other components of video modification system 100 over network 160 to modify video data. For example, video modification server 110 may modify video data stored in video database 130 to incorporate dynamic resource data (e.g., advertisement information) stored in dynamic resource database 140 into a video, and send the modified video to server 125 and/or client devices 120.

Video modification server 110 may include a processor 111, a memory 112, and a storage 113. Processor 111 may include one or more processing devices, such as a microprocessor or any other type of processor. Memory 112 may include one or more storage devices configured to store information used by processor 111 to perform certain functions related to disclosed embodiments. For example, memory 112 may store one or more video modification programs loaded from storage 113 or elsewhere that, when executed, enable video modification server 110 to modify video data to include dynamic resource data, such as advertisements, within the video, in accordance with one or more embodiments discussed below. Storage 113 may include a volatile or non-volatile, magnetic, semiconductor, tape, optical, removable, nonremovable, or other type of storage device or computer-readable medium.

In certain embodiments, a user at client device 120 may supply the video data and the dynamic resource data (e.g., advertisement information) to video modification server 110 via network 160. In these embodiments, video modification server 110 may receive the video data and the dynamic resource data and may store the data locally or in video database 130 and dynamic resource database 140. The user at client device 120 may then interact with video modification server 110, e.g., via one or more user interfaces, discussed in greater detail below, to incorporate the dynamic resource data into the video. In certain embodiments, video modification server 110 may automatically determine how to integrate the dynamic resource data into the video.

In embodiments where a user at client device 120 supplies both the video and the dynamic resource data to video modification server 110, the owner or administrator of video modification server 110 may charge a fee to the user at client device 120. For example, the user may pay a per-video fee to use video modification server 110 or may pay a subscription fee to use the services of video modification server 110 for one or more videos. In one embodiment, the user may be an advertiser. That is, the advertiser may supply a video to be modified and the dynamic resource data to video modification server 110. In this embodiment, the video to be modified may be a pre-existing advertisement video. The dynamic resource data may be added to the pre-existing advertisement video to create a modified version of the original advertisement video. The advertiser may similarly pay a fee to use video modification server 110 in this way, or may subscribe to a video modification service that allows it to use video modification server 110.

In other embodiments, a third party, such as a user at client device 120 or at some other device on network 160 may supply the video data and an advertiser may supply the advertisement information. In these embodiments, the advertiser may pay a fee to the administrator of video modification server 110. This fee may be based on a number of times the ad is played within a video, e.g., on a website hosted by content server 125, may be a flat fee, or may be calculated by any other method. The administrator may split part of the fee earned with the user that supplied the video data. For example, processor 111, or some other processor, may determine a fee to be paid to the user. The fee paid to the user may be determined based on a popularity of the video, a predetermined fixed percentage, or any other method.

In certain embodiments, a user at client device 120 may request content from content server 125. For example, client device 120 may send an HTTP request for a web page stored on content server 125. The content may include a video that has been modified by video modification server 110 to include dynamic resource data (e.g., advertisement information). The video itself may be displayed as an advertisement within the web page displayed on client device 120. In these embodiments, the videos and/or the advertisement information may be provided, e.g., by an advertiser, by an administrator of content server 125, and or by a third party. For example, video database 130 may include one or more of these videos to be displayed by content server 125 on a web page. Video modification server 110 may incorporate dynamic resource data stored at dynamic resource database 140 into the videos and may send the videos to content server 125 for display on the web page. In other embodiments, video modification server 110 may send the videos directly to client device 120.

In these embodiments, video modification server may generate modified videos that are customized based on information stored in user profile 140. For example, when a client device 120 sends a request such as an HTTP request to content server 125, the request may include one or more parameters that may identify client device 120, such as an IP address, MAC address, etc. Content server 125 may send these parameters to video modification server 110. Video modification server 110 may then access user profile database 140 to look up information regarding client device 120 or a user of client device 120. Video modification server 110 may then choose from among dynamic resource data (e.g., advertisement information) stored in dynamic resource database 140 to be incorporated into the modified video based on these parameters.

Thus, video modification server 110 may dynamically generate a modified video to incorporate advertisement information targeted to client device 120 and/or its user based on information stored in user profile database 140. This way, users at different client devices 120 may receive video content with advertisements customized to their particular habits, history, location, and/or demographic information. For example, while the underlying video being displayed to two different users may be the same, the advertisement information incorporated into the videos may be different for each user, and may be chosen based on some information about the user and/or the client device on which the user is operating.

In an exemplary embodiment of customizing video content sent to client device 120, video modification server 110 may determine a general location of client device 120 and may customize advertising content incorporated into the video based on this location. For example, video modification server 110 may determine the general location based on information stored in user profile database 140 or parameters received from content server 125. This may include, e.g., the current IP address of the client device, location information from a global positioning receiver, or any other data used to determine location information. Video modification server 110 may customize the advertising content incorporated into the video based on this location. For example, if the advertising information being incorporated is for a retailer or other business, then video modification server 110 may incorporate the address of the nearest retail location into the modified video that is being sent to client device 120. This information may be displayed as text (e.g., listing the address of the location) and/or as an image, (e.g., as a map). In this embodiment, video modification server 110 may also incorporate into the modified video promotions, sales, specials, store hours, etc., of to the nearest retail location.

Video modification server 110 may also customize the dynamic resource data (e.g., advertisement information) being incorporated into the modified video based on other parameters. For example, video modification server 110 may customize the advertisement information based on time of year, time of day, current events, or any other information. In one example, video modification server 110 may customize the advertisement information such that advertisements incorporated into the video data during the winter months are representative of winter activities, e.g., snow shovels, hot chocolate mix, etc., while advertisements incorporated during summer months are representative of summer activities, e.g., swimwear, outdoor activities, etc.

In still other embodiments, video modification server 110 may customize the dynamic resource data (e.g., advertisement information) being incorporated into the modified video based on user feedback. For example, video modification server 110 may receive feedback from users of client devices 120, e.g., indirectly via a number of times a video has been viewed and/or directly via customer surveys or other feedback provided at the end of a video. Video modification server 110 may also receive feedback from an administrator of content server 125 such as data representing a change in network traffic correlated to particular advertisement information. Video modification server 110 may then customize which advertisement information is incorporated into the modified video based on this feedback.

In other embodiments, video modification server 110 may customize the dynamic resource data being incorporated into the modified video based on parameters that define dynamic resource size and display time constraints for a particular video. For example, it may be determined that a video is to be modified at a particular time and for a particular period (e.g., during a particular set of frames), and within a particular location of those frames. Thus, video modification server 110 may choose a dynamic resource that fits within those constraints.

Video modification server 110 may send the modified video directly to client device 120, or may send the video to content server 125, which may then send the video to client device 120, e.g., as part of a web page. In certain embodiments, video modification server 110 may stream the modified video to client device 120 and/or content server 125. Thus, video modification server 110 may be capable of quickly modifying video data to include the customized advertisement content such that the modified video can be streamed to the user. For example, video modification server 110 may implement one or more processes discussed below to modify video data quickly such that it is capable of being streamed to a user at user device 120.

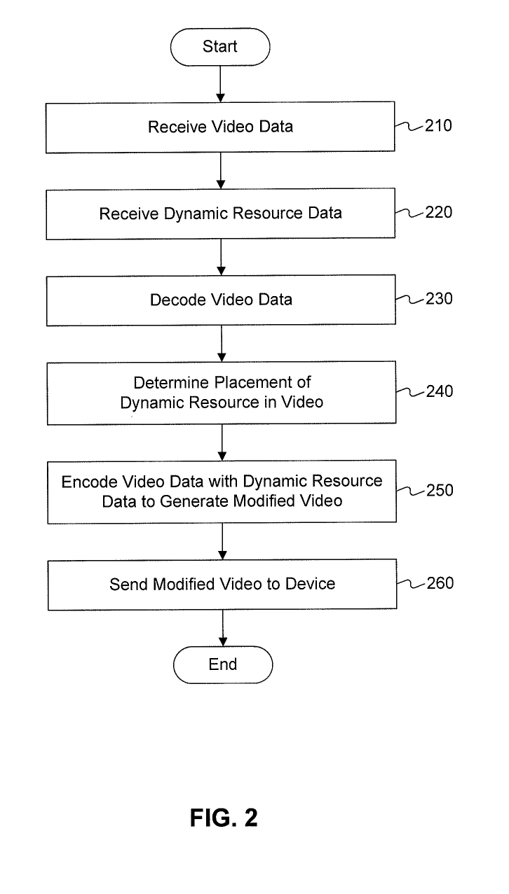

FIG. 2 is a flow diagram illustrating an exemplary process for generating a modified video that may be performed by one or more components of the video modification system shown in FIG. 1, such as video modification server 110, consistent with disclosed embodiments. For example, video modification server 110 may receive video data to be modified (step 210). As discussed, this video data may be received from user devices 120, content server 125, video database 130, or other sources, such as advertising companies, or other entities.

Video modification server 110 may also receive dynamic resource data to be incorporated into the video of the received video data (step 220). For example, as discussed above, video modification server 110 may receive dynamic resource data in the form of advertisement data. This information may be received from, e.g., user devices 120, content server 125, dynamic resource database 140, or other sources, such as advertising companies or other entities. Moreover, video modification server 110 may receive customized dynamic resource data in accordance with the embodiments discussed herein. For example, video modification server 110 may select customized or targeted advertising data based on information stored in user profile database 150, or other information received from user device 120, and/or content server 125.

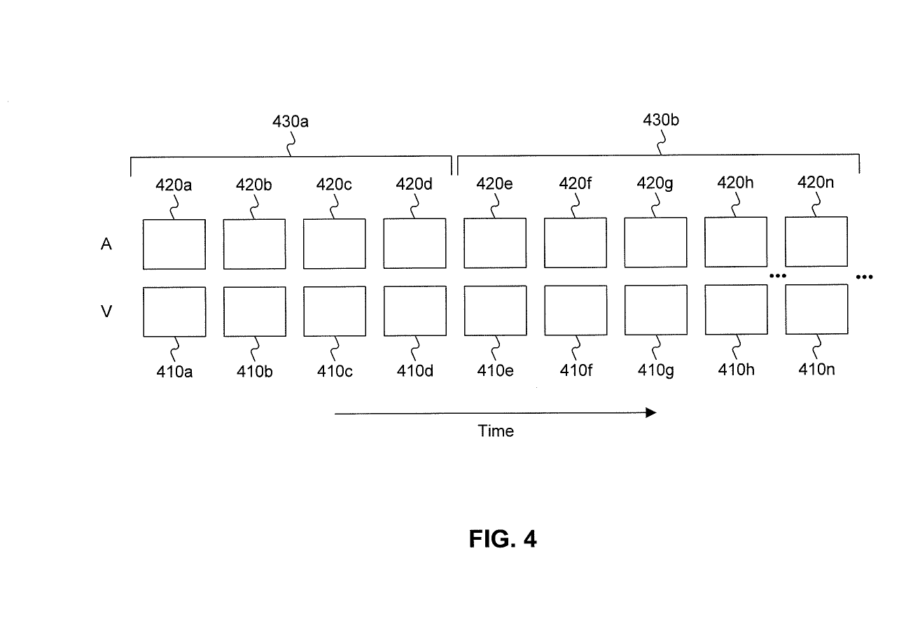

Video modification server 110 may decode the received video data, e.g., by separating the data into individual frames of audio and video data (step 230). For example, video modification server 110 may decode the video into multiple video frames representing discrete points in time or periods of time during the video. Video modification server 110 may also break the video down into multiple audio frames representing corresponding points in time or periods of time during the video, if audio was included with the original video data. An example of decoded audio and video frames is shown in FIG. 4, discussed in greater detail below.

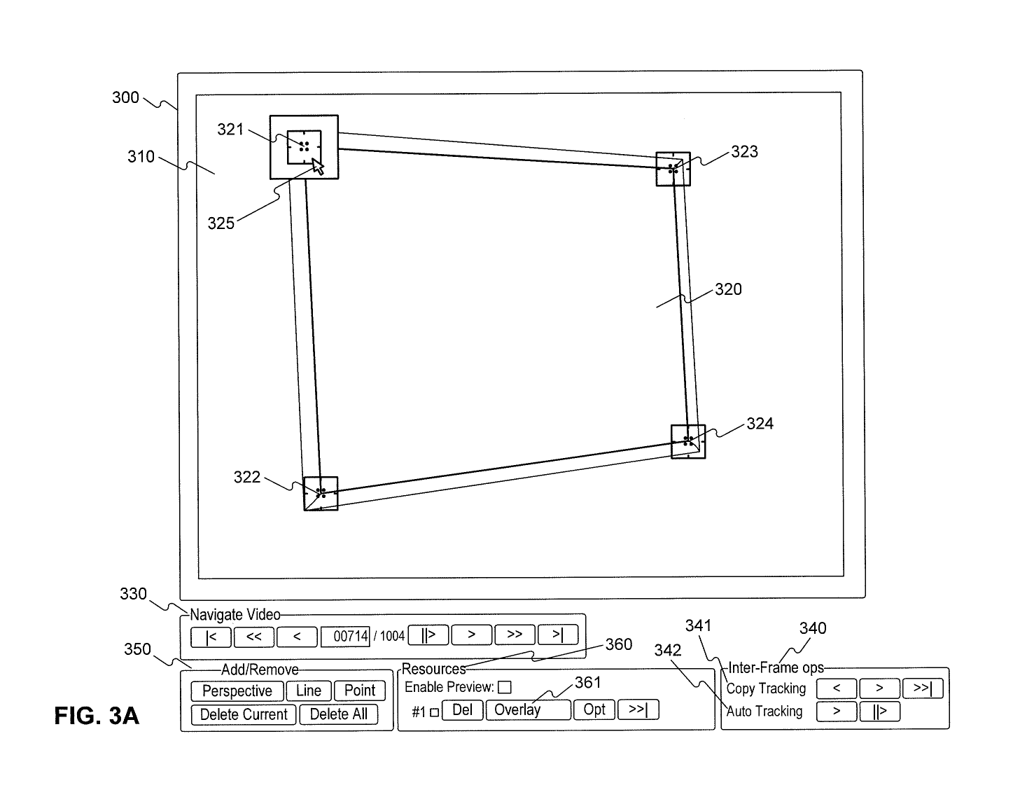

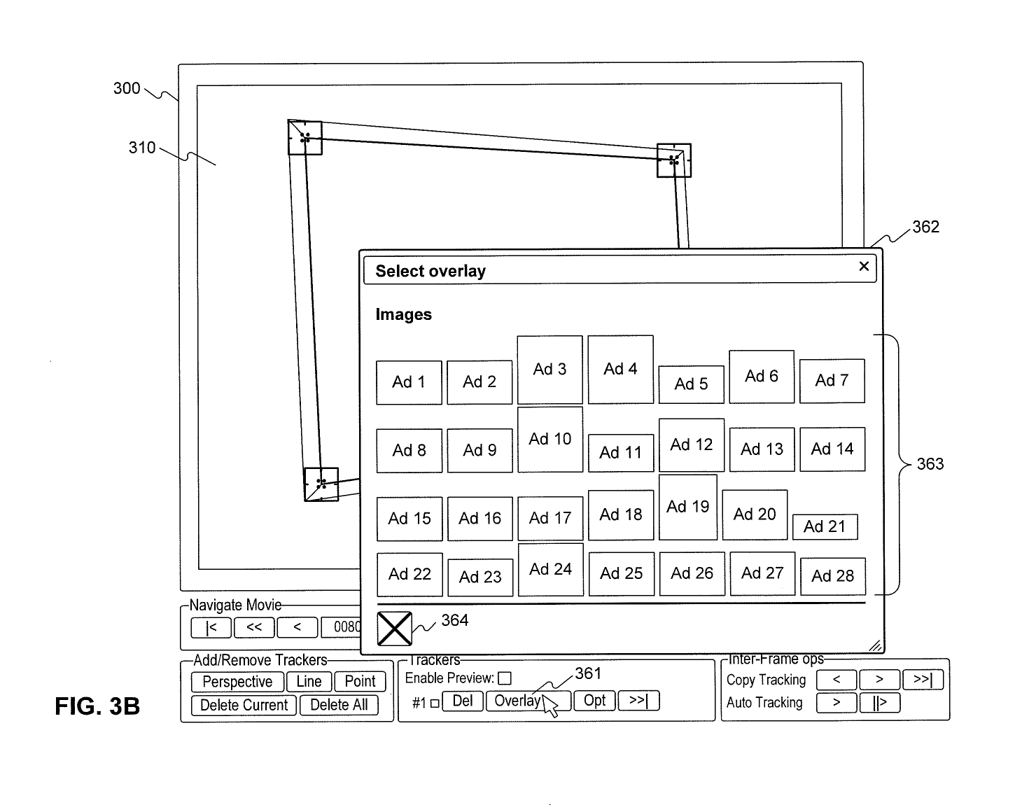

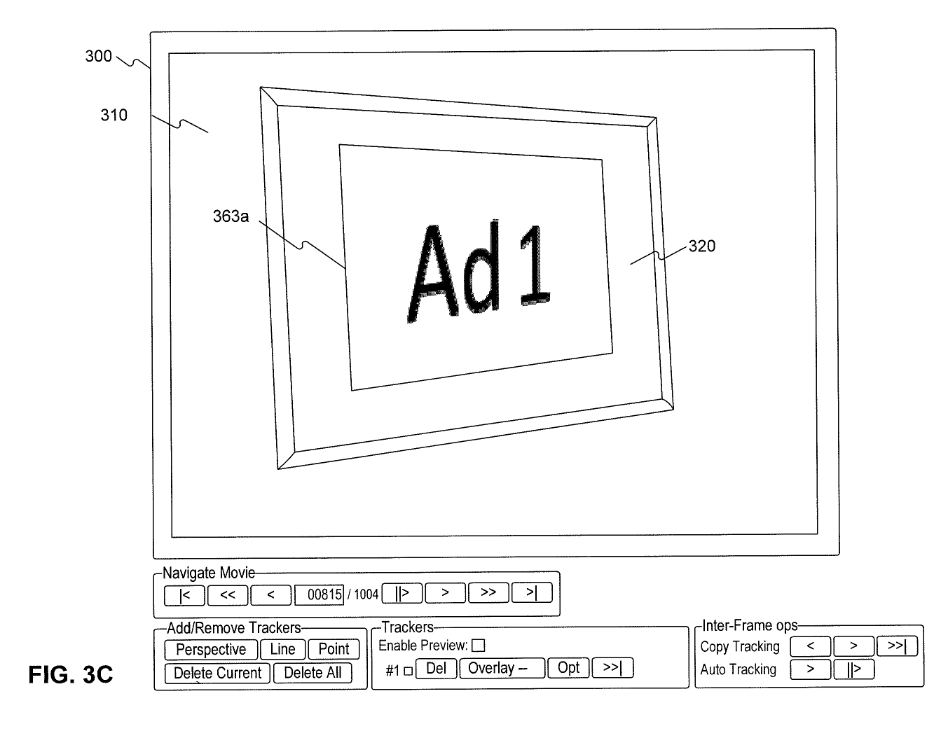

Video modification server 110 may also determine a placement of the dynamic resources within the video (step 240). For example, video modification server 110 may determine the frames of the video within which the dynamic resource data will be placed, as well as a positioning within each of the frames of the data. In certain embodiments, the placement of the dynamic resources within the video may be predetermined. For example, if the video data is provided by an advertiser, the advertiser may have already determined the frames during which the advertisement data will appear as well as the physical placement within the individual frames. In other embodiments, video modification server 110 may determine the placement of the dynamic resources based on user input. Both the user and the advertiser in the two embodiments discussed above may instruct video modification server 110 when (e.g., what frames) and where (e.g., the location within each frame) to place the dynamic resources within the video using a graphical user interface, such as the one discussed below with regard to FIGS. 3A-3C.

In other embodiments, video modification server 110 may automatically determine when and where to place the dynamic resources in the video. For example, video modification server 110 may include one or more programs to analyze the content of the video data to determine a number of frames that are suitable for incorporating dynamic resources. By adding up a number of consecutive suitable frames, video modification server may determine a length of time during which dynamic resources may be used. Additionally, video modification server 110 may include one or more programs to determine a recommended size of the dynamic resources to be placed in the video. For example, video modification server 110 may include a facial recognition program that may recognize images of faces in the video and ensure that a face of a person is not obscured or covered by dynamic resources such as advertisements. In some embodiments, video modification server 110 may then use the recommended length of time and size for the dynamic resource data as criteria for either resizing previously-received dynamic resource data or searching dynamic resource database 140 for additional advertisements that meet the time and size recommendations.

Video modification server 110 may encode the video data with the dynamic resource data to generate a modified video (step 250). As discussed in greater detail below, video modification server 110 may distinguish between static frames (i.e., frames into which dynamic resource data may not be inserted) and dynamic frames (i.e., frames into which dynamic resource data may be inserted) when encoding video data.

After generating the modified video, video modification server 110 may send the video to one or more devices (step 260). For example, video modification server 110 may send the video to content server 125 to be displayed in a web page served by content server 125, may send the video to client device 120, or may send the video anywhere else.

FIGS. 3A-3C illustrate an exemplary graphical user interface (GUI) 300 that may be used by a user to interact with video modification server 110 in order to modify a video. FIGS. 3A-3C illustrate how a user may select one or more frames within a video and locations within the one or more frames to identify areas for placing dynamic resources, choose dynamic resources to be inserted into the video, and preview the video. The user may be located at client device 120 or elsewhere and may communicate with video modification server 110 via network 160. For example, video modification server 110 may include one or more computer programs that enable video modification server 110 to display GUI 300 at a client device or any other device over network 160.

GUI 300 includes frame display section 310 for displaying a current frame of the video to a user, navigation section 330 for navigating through frames in a video, inter-frame operations section 340 for controlling dynamic resource display between frames, add/remove resource area section 350 for adding or removing areas for displaying dynamic resources, and dynamic resources section 360 for selecting a particular dynamic resource (e.g., advertisement information) to be displayed.

As shown in FIG. 3A, a user may interact with GUI 300 to select a resource area 320 in which dynamic resources (e.g., advertisement information) may be displayed a frame of a video. For example, a user may select corner points 321, 322, 323, and 324 to define resource area 320 in frame display section 310. The user may select these points by manipulating cursor 325 via a user interface device such as a keyboard, mouse, touch screen, etc. For example, to select corner point 321, a user may select “Point” button in resource area section 350, and then click on corner point 321. The user may do the same with corner point 322. Then, the user may select “Line” button in resource area section 350 and connect corner points 321 and 322 with a line to define an edge of resource area 320.

The user may also change the perspective of resource area 320. For example, as shown in FIG. 3A, resource area 320 is shown from a perspective such that its edges are not perpendicular with the edges of frame display section 310, giving the impression that resource area 320 is being viewed from an angle in three-dimensions. The user may select “Perspective” button in resource area section 350 to change the perspective of resource area 320, e.g., by rotating it about one or more axes.

In certain embodiments, video modification server 110 may store one or more programs that enable it to automatically detect resource area 320. For example, video modification server 110 may include a program that enables it to detect objects within the video frame, or corners or edges of those objects. For example, resource area 320 may correspond to a mirror or picture hanging on a wall. Video modification server 110 may detect the edges of the mirror or picture shown in frame display section 310 to automatically determine the location of resource area 320 that corresponds to the mirror or picture hanging on the wall.

Once resource area 320 is defined for a frame, a user may instruct video modification server 110 to copy the tracking to subsequent or previous frame(s), e.g., using copy tracking buttons 341 of inter-frame operations menu 340. This may cause video modification server 110 to copy the location of resource area 320 to the next frame. The user may also instruct video modification server 110 to automatically determine the resource area for the next frame(s), e.g., by using auto tracking buttons 342. This may cause video modification server 110 to copy resource area 320 to the subsequent frame, and then automatically match resource area 320 to a location in the subsequent frame, e.g., using the automatic detection programs discussed above.

A user may also use navigate video menu 330 to navigate among frames in the video. For example, navigate video menu 330 shows that the current frame in FIG. 3A is frame 714/1004.

When resource area 320 has been selected for a frame or for multiple frames, a user may use GUI 300 to select dynamic resources (e.g., advertisement information) to be incorporated into the video, as shown in FIG. 3B. For example, if a user selects overlay button 361 of dynamic resources menu 360, video modification server 110 may display window 362 including a list of dynamic resources 363 to be displayed in resource area 320. If a user selects one of these resources, then the resource may be incorporated into the video in resource area 320. Dynamic resources 363 may include any combination of audio, textual, graphical, and video data, for example. A user may close window 362 by clicking button 364.

The user may also interact with GUI 300 to preview the modified video frames. For example, FIG. 3C shows an exemplary dynamic resource 363a that may be incorporated into resource area 320 of display section 310. As shown in FIG. 3C, video modification server 110 may alter the perspective of dynamic resource 363a corresponding to the perspective of resource area 320 such that dynamic resource 363a appears to be displayed on the surface of resource area 320.

Video modification server 110 may also modify dynamic resource 363a to account for the original content of resource area 320, such as the material previously depicted in this area. For example, glass surfaces may show a reflection while plain walls would typically not. Other surfaces may have lights and shadows. To make the dynamic resource (e.g., advertisement information) appear as if it were part of the original video footage, video modification server 110 may include one or more computer programs with different algorithms for modifying the surface appearance of dynamic resource 363a to match that of the original content displayed in resource area 320. For example, if resource area 320a was previously a mirror or picture frame, then video modification server 110 may modify dynamic resource 363a such that the modified video retains the appearance of the resource area 320 (e.g., shiny, reflective) to make dynamic resource 363a appear as if it were part of the original video.

FIG. 4 is an exemplary block diagram illustrating modification of video data that may be performed by video modification server 110, consistent with disclosed embodiments. FIG. 4 shows video data that has been decoded and represented as frames. For example, the video data may include video frames 410a-410n arranged in a time series. Each video frame 410 may correspond to a particular point or period of time in the time series, for example, and may display the video data for that time. The video data may also include audio frames 420a-420n that correspond to the same points in time as their respective video frames and may include audio data for that particular point in time.

As discussed above, video modification server 110 may distinguish between static frames (i.e., frames into which dynamic resource data may not be inserted) and dynamic frames (i.e., frames into which dynamic resource data may be inserted) for encoding video data. In certain embodiments, video modification server 110 may identify whether a particular frame is static or dynamic, and may group the frames into scenes based on this determination. For example, video modification server 110 may group consecutive frames of one type (e.g., static or dynamic) into one scene and may categorize the scene as being of the same type (e.g., static or dynamic) based on the categorization of its corresponding frames.

Video modification server 110 may determine whether a scene is static or dynamic by analyzing parameters in the scene description language (SDL) used to represent the frames in the movie. The SDL may include information that describes the operations used to compose audio and video frames. Video modification server 110 may determine whether a frame is static or dynamic by analyzing the SDL to determine whether a frame is using resources that are being determined by variable parameters at the time corresponding to the frame. In other words, video modification server 110 may use the SDL to determine whether dynamic resource data is being incorporated into a particular frame.

Using FIG. 4 as an example, video modification server 110 may determine that video frames 410a-410d are static frames and may determine that frames 420e-420n are dynamic frames. Thus, video modification server 110 may create static scene 430a that includes static frames 410a-410d and dynamic scene 430b that includes dynamic frames 420e-420n. Video modification server 110 may determine whether all of the frames in the video are static or dynamic, and may group frames into scenes based on the determination.

Video modification server 110 may also re-encode the frames in one or more of the static scenes. In certain embodiments, video modification server 110 may re-encode the static scenes before the dynamic resource data is chosen and/or inserted into the dynamic frames. This way, the static portions of the video may be encoded beforehand to reduce the amount of real-time processing required for customizing the video. Then, video modification server 110 may re-encode the frames in the dynamic scenes, such as scene 430b, after determining the dynamic resources to be inserted into the video. This may enable video modification server 110 to reuse an underlying video to create multiple custom modified videos having different dynamic resources incorporated therein without having to process the static frames for each modification.

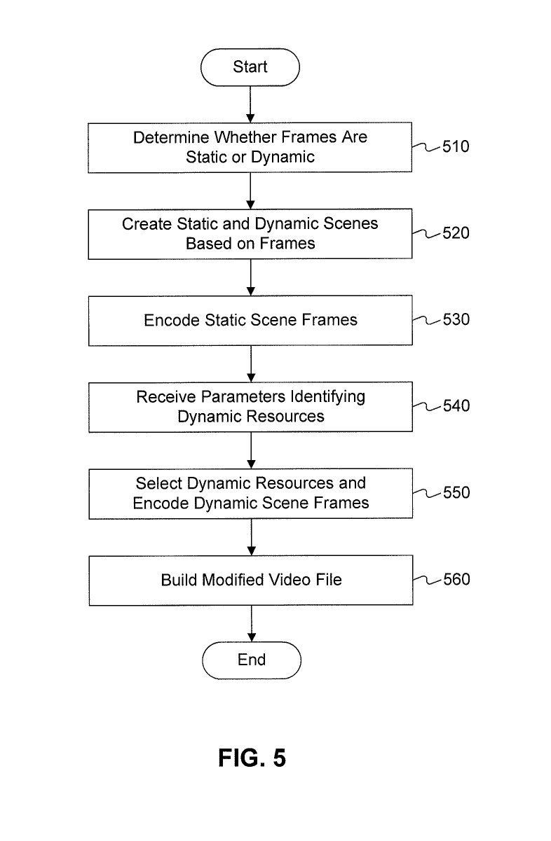

FIG. 5 is a flow diagram of an exemplary process for analyzing decoded video data and incorporating dynamic resources into a modified video, consistent with disclosed embodiments. The process of FIG. 5 may be performed by video modification server 110. For example, video modification server 110 may determine whether particular frames within a video are static or dynamic (step 510). As discussed above, video modification server 110 may analyze the SDL used to represent each frame to determine whether a frame is static or dynamic. Moreover, video modification server 110 may analyze both the audio and video portions of each frame. If one of either the audio or video portions is determined to be dynamic, then video modification server 110 may determine that the entire frame is dynamic.

Video modification server 110 may create static or dynamic scenes based on the frame types as determined in step 510 (step 520). For example, video modification server 110 may create a scene of a particular type (static or dynamic) that includes consecutive frames of that type. Thus, if x number of consecutive frames are determined to be dynamic, then video modification server 110 may create a dynamic scene that includes all or a portion of the x consecutive frames. Video modification server 110 may group frames into scenes, e.g., by modifying the SDL used to represent the video.

Video modification server 110 may also encode one or more of the static scene frames (step 530). For example, video modification server 110 may encode all of the frames in the static scenes of a video. Moreover, in certain embodiments video modification server 110 may encode the static scenes prior to receiving a request for creating a modified video including dynamic resources, or before selecting the dynamic resources to incorporate into the video.

Video modification server 110 may receive parameters identifying dynamic resources to be incorporated into the modified video (step 540). For example, video modification server 110 may receive an indication of the advertisement data to be incorporated into the dynamic scenes of the video. In certain embodiments, the parameters identifying the dynamic resources to be incorporated may be provided by the component of system 100 that is requesting the dynamic movie. For example, if content server 125 (or client device 120) is requesting the dynamic movie, content server 125 (or client device 120) may send an HTTP request to video modification server 110 that includes the parameters. The parameters may also be defined as part of an HTML link associated with the request. For example, the following link: http://hostname/dynamicmovie.mp4?param1=abc&param2=21 may represent a request for a dynamic movie designating two parameters, “abc” and “21.” These parameters may be expressed in any format consistent with disclosed embodiments. Moreover, these parameters may include any information used to identify dynamic resources. For example, the parameters may request a particular dynamic resource itself, specify a size of a desired dynamic resource and/or a duration during which a dynamic resource may appear, provide targeting information about a user such as geographic location, demographics, browsing history, or other information, etc.

In other embodiments, the parameters may be provided separately from the request for the dynamic video. For example, a component of system 100 such as content server 125 may request a dynamic movie from video modification server 110 and video modification server 110 may apply predetermined parameters corresponding to content server 125 in order to determine the dynamic resources to use.

Based on the received parameters, video modification server 110 may select dynamic resources to be incorporated into the dynamic frames of the video and encode the dynamic scene frames (step 550). For example, as discussed above with regard to FIG. 1, video modification server 110 may select dynamic resources from dynamic resource database 140 using any of the received parameters. After choosing the dynamic resources, video modification server 110 may encode the dynamic frames including the dynamic resources. Then, video modification server 110 may build the modified video file including both the static and dynamic scenes (step 560).

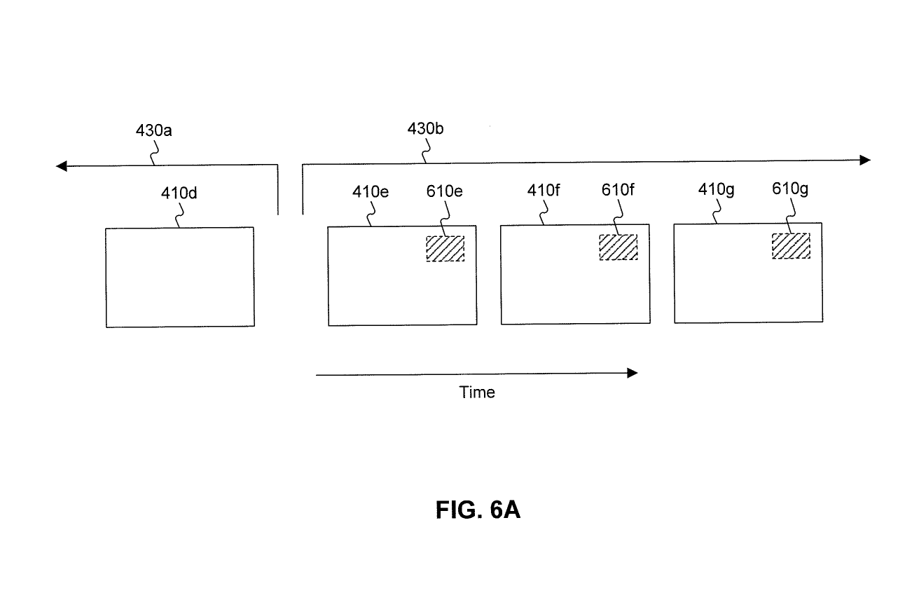

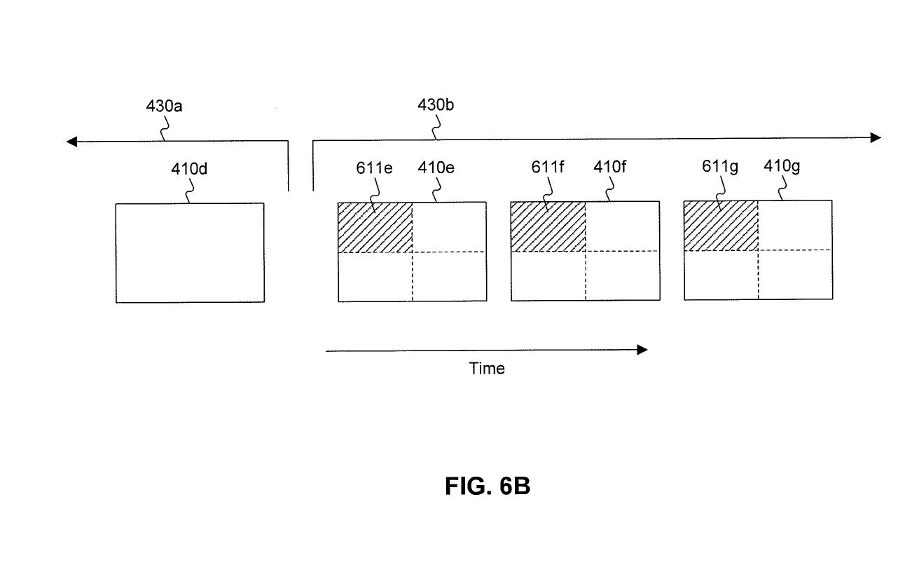

FIGS. 6A-6B are block diagrams illustrating exemplary modifications of dynamic scenes within video data that may be performed by video modification server 110, consistent with disclosed embodiments. For example, FIG. 6A shows part of the time series shown in FIG. 4 that includes static video frame 410d and dynamic video frames 410e-410g. As shown in FIG. 6A, dynamic video frames 410e-410g may include corresponding dynamic resource areas 610e-610g. These resource areas may be predetermined, or may be determined based on any of the processes discussed above, such as using GUI 300 shown in FIG. 3. Dynamic resources areas 610e-610g may define areas in which dynamic resources may be incorporated into dynamic frames 420e-420g, respectively.

In certain embodiments, video modification server 110 may encode the portions of dynamic frames 420e-420g that do not include dynamic resource areas 610e-610g before the dynamic resource data to be inserted into dynamic resources areas 610e-610g is chosen and/or inserted into dynamic frames 420e-420g. This way, the static portions of the dynamic frames may be encoded beforehand to reduce the amount of real-time processing required to customize the video. Then, video modification server 110 may re-encode dynamic resource areas 610e-610g after determining the dynamic resources to be inserted into the video, e.g., based on user input, information from user profile database 150, or any of the other information discussed above. This may enable video modification server 110 to reuse an underlying video for creating multiple custom modified videos having different dynamic resources without having to process the static portions of the dynamic frames for each modification.

FIG. 6B shows another exemplary embodiment of how video modification server 110 may encode parts of a dynamic frame before inserting the dynamic resource data into dynamic resource areas. For example, in FIG. 6B, dynamic scenes 420e-420g are divided into quadrants. In this example, it is determined that the upper left quadrants 621e-621g of each corresponding dynamic frame 420e-420g includes a dynamic resource area, while the remaining quadrants do not. In this embodiment, video modification server 110 may encode the quadrants of dynamic frames 420e-420g that do not include dynamic resource areas before the dynamic resource data to be inserted is chosen and/or inserted into dynamic frames 420e-420g. Video modification server 110 may then re-encode quadrants 621e-621g that include the dynamic resource areas after the dynamic resources are inserted.

The dynamic resource areas in frames 420e-420g need not be the same size and shape as quadrants 621e-621g. For example, video modification server 110 may determine whether any part of a quadrant includes a dynamic resource area, and if it does, video modification server 110 may designate that quadrant as a dynamic quadrant.

Moreover, while frames 420e-420g are shown in FIG. 6B as being divided into quadrants, those skilled in the art will understand that any division of frames 420e-420g may be used, including, e.g., dividing the frames in half, sixths, eighths, or any other division. Further, any type of geometric shapes may be used to divide the frames in any way, consistent with disclosed embodiments.

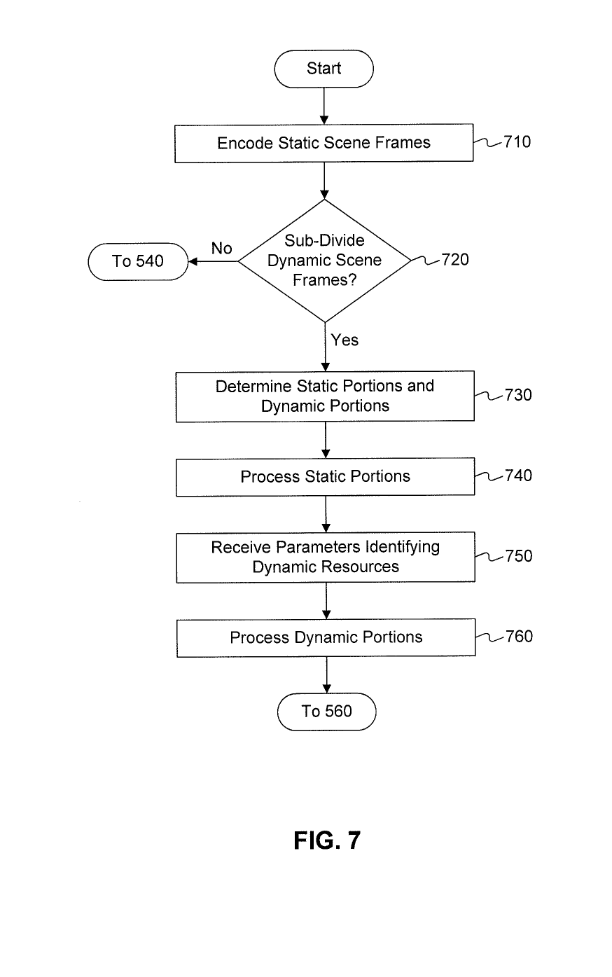

FIG. 7 is a flow diagram of an exemplary process for modifying video data that may be performed by video modification server 110, consistent with disclosed embodiments. This process may be performed, for example, after step 520 in FIG. 5.

Video modification server 110 may encode the static frames in the video that have been identified, e.g., in accordance with one or more of the processes discussed above (step 710).

Video modification server 110 may determine whether to sub-divide the dynamic scene frames to process static portions in advance of dynamic portions (step 720). For example, video modification server 110 may receive a command to pre-process the static portions of the dynamic frames in order to decrease processing time after a request for a video is received. In other embodiments, video modification server 110 may be preconfigured to sub-divide the dynamic scene frames for one or more videos to be modified. If, at step 720, video modification server 110 determines not to sub-divide the dynamic frames (step 720, No), then video modification server 110 may proceed to step 540 of FIG. 5 and proceed without subdividing the frames.

If, at step 720, video modification server 110 determines to sub-divide the dynamic frames (step 720, Yes), then video modification server 110 may determine which portions of the divided frames are static and which are dynamic (step 730).

Video modification server 110 may process the static portions of the dynamic frames (step 740). For example, as discussed above, video modification server 110 may encode the static portions of the dynamic frames before receiving parameters for identifying dynamic resources to incorporate into the dynamic areas.

Video modification server 110 may then receive parameters identifying dynamic resources and may incorporate the dynamic resources into the dynamic portions of the dynamic frames (step 750).

After the dynamic resources are incorporated, video modification server 110 may process the dynamic portions of the dynamic frames (step 760). For example, video modification server 110 may encode the dynamic portions that include the dynamic resources. Video modification server 110 may then proceed to step 560 in FIG. 5 to build the modified video file.

The foregoing descriptions have been presented for purposes of illustration and description. They are not exhaustive and do not limit the disclosed embodiments to the precise form disclosed. Modifications and variations are possible in light of the above teachings or may be acquired from practicing the disclosed embodiments. For example, the described implementation includes software, but the disclosed embodiments may be implemented as a combination of hardware and software or in firmware. Examples of hardware include computing or processing systems, including personal computers, servers, laptops, mainframes, micro-processors, and the like. Additionally, although disclosed aspects are described as being stored in a memory on a computer, one skilled in the art will appreciate that these aspects can also be stored on other types of computer-readable storage devices, such as secondary storage devices, like hard disks, floppy disks, a CD-ROM, USB media, DVD, or other forms of RAM or ROM.

Other embodiments will be apparent to those skilled in the art from consideration of the specification and practice of the embodiments disclosed herein. The recitations in the claims are to be interpreted broadly based on the language employed in the claims and not limited to examples described in the present specification or during the prosecution of the application, which examples are to be construed non-exclusive. Further, the steps of the disclosed methods may be modified in any manner, including by reordering, combining, separating, inserting, and/or deleting steps. It is intended, therefore, that the specification and examples be considered as exemplary only, with a true scope and spirit being indicated by the following claims and their full scope equivalents.

What is claimed is:

1. A computer-implemented method for incorporating advertisement information into a video, the method comprising:
receiving a request for a modified video;
receiving at least one parameter for determining advertisement information to be included in the modified video;
selecting the advertisement information based on the received parameter;
determining, by a processor, an advertisement area in a video for the advertisement information to be located;
generating, by the processor, the modified video by integrating the advertisement information into the advertisement area in the video; and
sending, by the processor, the modified video to one or more devices.

2. The method of claim 1, further comprising:
receiving the advertisement information from an advertiser;
receiving the video from a third party that is not the advertiser;
collecting a fee from the advertiser for generating the modified video; and
compensating the third party with at least part of the fee after sending the modified video to the one or more devices.

3. The method of claim 1, further comprising:
receiving, via a graphical user interface, selection criteria including at least one of: a size of the advertisement area in the video, a shape of the advertisement area in the video, and a duration during which the advertisement area in the video is displayed; and
determining, by the processor, a location of the advertisement area in at least one frame of the video based on the received selection criteria.

4. The method of claim 3, further comprising:
determining, based on the selection criteria, a perspective from which the advertisement area in the video is being viewed; and
displaying the advertisement information in the advertisement area in accordance with the determined perspective of the advertisement area.

5. The method of claim 1, generating the modified video further comprising:
identifying one or more static frames within the video; and
encoding the identified static frames before selecting the advertisement information to be incorporated into the video.

6. The method of claim 5, generating the modified video further comprising:
identifying one or more dynamic frames within the video;
identifying one or more static portions within the identified dynamic frames; and
encoding the identified static portions before selecting the advertisement information to be incorporated into the video.

7. The method of claim 1, wherein the at least one parameter for determining the advertisement information to be included in the modified video is included in the request for the modified video.

8. The method of claim 1, wherein the at least one parameter for determining advertisement information to be included in the modified video includes at least one of: location information related to a client device, browsing history related to a client device, and a time of day during which the request for the modified video was received.

9. The method of claim 1, wherein the at least one parameter for determining advertisement information includes at least one of: a user's gender, age, or geographic location.

10. An apparatus for incorporating advertisement information into a video, the device comprising:
one or more processors; and
one or more memories storing instructions that, when executed by one or more of the processors, enable the processor to:
receive a request for a modified video;
receive at least one parameter for determining advertisement information to be included in the modified video;
select the advertisement information based on the received parameter;
determine an advertisement area in a video for the advertisement information to be located;
generate the modified video by integrating the advertisement information into the advertisement area in the video; and
send the modified video to one or more devices.

11. The apparatus of claim 10, the instructions stored in the one or more memories further enabling one or more of the processors to:
receive the advertisement information from an advertiser;
receive the video from a third party that is not the advertiser;
determine a fee to be collected from the advertiser for generating the modified video; and
determine a percentage of the fee to be paid to the third party after sending the modified video to the one or more devices.

12. The apparatus of claim 10, the instructions stored in the one or more memories further enabling one or more of the processors to:
generate instructions for displaying a graphical user interface;
receive, via the graphical user interface, selection criteria including at least one of: a size of the advertisement area in the video, a shape of the advertisement area in the video, and a duration during which the advertisement area in the video is displayed; and
determine a location of the advertisement area in at least one frame of the video based on the received selection criteria.

13. The apparatus of claim 12, the instructions stored in the one or more memories further enabling one or more of the processors to:
determine, based on the selection criteria, a perspective from which the advertisement area in the video is being viewed; and
display the advertisement information in the advertisement area in accordance with the determined perspective of the advertisement area.

14. The apparatus of claim 10, the instructions stored in the one or more memories further enabling one or more of the processors to:
identify one or more static frames within the video; and
encode the identified static frames before selecting the advertisement information to be incorporated into the video.

15. The apparatus of claim 14, the instructions stored in the one or more memories further enabling one or more of the processors to:
identify one or more dynamic frames within the video;
identify one or more static portions within the identified dynamic frames; and
encode the identified static portions before selecting the advertisement information to be incorporated into the video.

16. The apparatus of claim 10, wherein the at least one parameter for determining the advertisement information to be included in the modified video is included in the request for the modified video.

17. The apparatus of claim 10, wherein the at least one parameter for determining advertisement information to be included in the modified video includes at least one of: location information related to a client device, browsing history related to a client device, and a time of day during which the request for the modified video was received.

18. The apparatus of claim 10, wherein the at least one parameter for determining advertisement information includes at least one of: a user's gender, age, or geographic location.

19. A method for dynamically modifying a video, the method comprising:
storing, in a database in memory, a video to be modified, the video including a plurality of static frames to which advertising information may not be added, and a plurality of dynamic frames to which advertising information may be added;
receiving a request to display the video, the request including at least one parameter for determining advertisement information to be included in the video;
determining, by a processor, the advertisement information to be included in the video based on the at least one parameter in the received request to display the video;
modifying the video by integrating the advertisement information into at least one of the dynamic frames of the video; and
sending the modified video to one or more devices.

20. The method of claim 19, further comprising:
encoding a plurality of the static frames included in the video before receiving the request to display the video; and
storing the encoded static frames in the database.

21. The method of claim 19, further comprising:
receiving the advertisement information from an advertiser;
receiving the video from a third party that is not the advertiser;
collecting a fee from the advertiser for generating the modified video; and
compensating the third party with at least part of the fee after sending the modified video to the one or more devices.

22. The method of claim 21, wherein the part of the fee paid to the third party is determined based on the popularity of the video or a predetermined percentage of the fee collected from the advertiser.

23. The method of claim 19, further comprising:
receiving the video and the advertisement information from the same entity, wherein the video includes a pre-existing advertisement; and
creating an augmented advertisement by modifying the video to integrate the advertisement information into at least one of the dynamic frames of the video including the pre-existing advertisement.
